(19) United States
(12) Patent Application Publication
(10) Pub. No.: US 2008/0308060 A1
(43) Pub. Date: Dec. 18, 2008

(54) Air intake device for internal combustion engine

(75) Inventor: Makoto Shigematsu, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/155,523

(22) Filed: Jun. 5, 2008

(30) Foreign Application Priority Data
Jun. 12, 2007 (JP) 2007-154724

(51) Int. Cl. F02M 35/10

(52) U.S. Cl. 123/184.56

(57) ABSTRACT

An air intake device has a surge tank and an intake manifold for distributing intake air between cylinders of an in-line cylinder engine. Manifold pipes of the intake manifold are aligned in a longitudinal direction of the surge tank and disposed substantially perpendicular to a first wall of the surge tank. A first end of each manifold pipe is connected to the first wall of the surge tank and a second end of each manifold pipe is to be connected to the corresponding cylinder. The first end of each manifold pipe has a protruded portion that is protruded in the surge tank through the first wall and has a funnel shape in which an opening increases toward its end. An opening area of the end of the protruded portion is varied between the manifold pipes in accordance with velocity of the intake air flowing toward the end of each protruded portion in the surge tank.

### CROSS REFERENCE TO RELATED APPLICATION

This application is based on Japanese Patent Application No. 2007-154724 filed on Jun. 12, 2007, the disclosure of which is incorporated herein by reference.

### FIELD OF THE INVENTION

The present invention relates to an air intake device for an internal combustion engine. More particularly, the present invention relates to the air intake device having a surge tank and an intake manifold having manifold pipes for distributing intake air between cylinders of the internal combustion engine from the surge tank.

### BACKGROUND OF THE INVENTION

In general, intake air to be introduced in an internal combustion engine is filtered through an air cleaner and then introduced in a throttle body. After the flow rate of the intake air is adjusted by a throttle valve of the throttle body, the intake air is led through an air intake pipe and is introduced in a surge tank. The surge tank is in communication with cylinders of the internal combustion engine through an intake manifold. The intake manifold has plural manifold pipes that are correspondingly connected to the cylinders. Thus, the intake air is distributed between the cylinders through the manifold pipes of the intake manifold.

The intake air passes through the surge tank with specific velocity distribution. The specific velocity distribution is caused depending on the length of the intake pipe, the bend shape of the intake pipe and the like. Therefore, the surge tank has a predetermined volume to convert dynamic pressure into static pressure so as to solve the velocity distribution and thereby to evenly distribute the intake air between the cylinders. However, depending on a mounting condition in a vehicle, it is difficult to provide the surge tank with a sufficient volume. In such a case, the specific velocity distribution will remain in the surge tank.

In the case where the specific velocity distribution remains in the surge tank, the intake air is likely to be more introduced in upstream manifold pipes with respect to the flow of the intake air in the surge tank. As a result, the volume of intake air is uneven between the cylinders of the engine. That is, the intake air is unevenly suctioned between the cylinders. If the difference of the volumes of intake air between the cylinders increases, combustion conditions of the cylinders are differentiated. It is difficult to stabilize the rotation of the engine. As such, vibration and noise are increased during idling. Also, an increase in an engine rotational speed is raised. Moreover, fluctuations of torque are caused during traveling. Accordingly, the performance of the engine will be deteriorated.

To evenly distribute the intake air between the cylinders, it is proposed to provide the surge tank with a distribution plate, as described in Japanese Unexamined Patent Application Publication No. 2002-235619, for example. The distribution plate is arranged in the surge tank such that the intake air is distributed in the manifold pipes of the intake manifold after being dispersed by colliding with an inner wall of the surge tank once. That is, because the flow of the intake air in the surge tank is disturbed, influence of the flow of the intake air on the volumes of air introduced in the cylinders will be reduced. In this way, distribution efficiency of the intake air is improved. However, since the specific velocity distribution is not sufficiently solved, if the disturbance of the flow of the intake air is further increased by the distribution plate, passage loss will be increased. As a result, air intake efficiency will be deteriorated.

As described in Japanese Unexamined Utility Model Application Publication No. 5-32764, it is proposed to gradually reduce a cross-sectional area of the surge tank as a function of distance from the vicinity of the throttle body, so as to equalize suction pressure of the intake air distributed between the manifold pipes from the surge tank. FIG. 2B shows an intake device 100 of the publication NO. 5-32764, and FIG. 2A shows suction pressure of cylinders #1 to #4 and unevenness of distribution of the intake air between the cylinders #1 to #4 by the intake device 100. The unevenness of distribution of the intake air shown in FIG. 2A is measured by the inventor this time. As shown in FIG. 2A, although the difference of suction pressure is reduced between a near manifold pipe 105, which is closer to a throttle body 103, and a far manifold pipe 105, which is farther from the throttle body 103, the unevenness of distribution of the intake air between the cylinders is large.

Specifically, the unevenness of distribution of the intake air between the cylinders #1 to #4 is greater than 3%. In such a case, performance deterioration of an engine 101 due to fluctuation of torque and deterioration of driving feeling such as noise and vibration during idling will be concerned. Because an allowable limit of the unevenness of distribution varies depending on every engine and every driving condition, an upper limit of the unevenness will not be determined indiscriminately. In fact, however, the distribution efficiency improves as the unevenness of distribution is small.

In FIG. 2A, the unevenness of distribution is shown by the difference of the amount of the intake air between cylinders relative to an average volume between the cylinders, based on measured data of the amount of intake air suctioned in the cylinders in WOT (wide open throttle) timing of an in-line four-cylinder engine. Also, the intake pressure is shown in negative pressure. The surge tank 104 is configured such that the cross-sectional area is gradually reduced with respect to a longitudinal direction thereof.

### SUMMARY OF THE INVENTION

With regard to an air intake device, it is necessary to consider mountability to a vehicle. In fact, the volume, structure and arrangement of a surge tank of the air intake device are restricted, and thus there is a limit to covert dynamic pressure of the flow of the intake air into static pressure. Therefore, to solve or absorb the influence of the dynamic pressure, which still remains, due to the specific velocity distribution in the surge tank, it will be necessary to consider a mechanism in a whole structure of the intake device including an intake manifold.

The present invention is made in view of the foregoing matter, and it is an object of the present invention to provide an air intake device for an in-line multiple cylinder engine, which is capable of substantially evenly distributing intake air between cylinders of the engine without reducing air intake efficiency.

According to a first aspect of the present invention, an air intake device includes a surge tank and an intake manifold. The surge tank has a substantially tubular body and an inlet port at an end of the tubular body for allowing intake air to flow in the tubular body. The tubular body has a first wall and a second wall. The second wall is curved such that a cross-sectional area of the tubular body gradually reduces as a function of distance from the inlet port in a longitudinal direction of the tubular body. The intake manifold has a plurality of manifold pipes for distributing the intake air from the surge tank between the cylinders of the engine. Each of the manifold pipes has a first end portion connected to the first wall of the surge tank and a second end portion to be connected to the corresponding cylinder of the engine. The manifold pipes are aligned in the longitudinal direction of the surge tank and disposed substantially perpendicular to the first wall of the surge tank. The first end portion of each manifold pipe has a protruded portion protruded in the surge tank. The protruded portion has a funnel shape in which an opening increases toward its end. An opening area of the end of the protruded portion is varied between the plurality of manifold pipes in accordance with velocity of the intake air flowing toward the end of each protruded portion in the surge tank.

Accordingly, influence of specific velocity distribution of the intake air in the surge tank is reduced without requiring an increase in the volume of the surge tank and a distribution plate. Air intake efficiency is improved and the intake air is substantially evenly distributed between the cylinders.

According to a second aspect of the present invention, an air intake device includes a surge tank and an intake manifold. The surge tank has a tank body and an inlet port at an end of the tank body for introducing intake into the tank body. The intake manifold has a plurality of manifold pipes for distributing the intake air from the surge tank between cylinders of an engine. The manifold pipes are aligned in a longitudinal direction of the tank body of the surge tank and disposed substantially perpendicular to the longitudinal direction of the tank body, each of the manifold pipes having a first end portion connected to the tank body and a second end portion to be connected to the corresponding cylinder. The first end portion of each manifold pipe has a protruded portion protruded in the surge tank. The protruded portion has a funnel shape in which an opening increases toward its end. An opening area of the end of the protruded portion is varied between the plurality of manifold pipes in accordance with velocity of the intake air flowing toward the end of each protruded portion in the surge tank.

For example, in a surge tank in which the cross-sectional area is reduced as a function of distance from the inlet port, an inertial force of the flow is caused. Also, passage loss is caused due to the length of the surge tank. For example, the opening area of the end of the protruded portion of a nearest manifold pipe and a furthest manifold pipe is greater than that of a middle manifold pipe, the nearest manifold pipe being nearest to the inlet port, the furthest manifold pipe being furthest from the inlet port, the middle manifold pipe being between the nearest manifold pipe and the furthest manifold pipe. In this case, velocity distribution at the ends of the protruded portions due to the inertial force and the passage loss is effectively absorbed, and hence even distribution of the intake air between the cylinders is further improved.

For example, the opening area of the end of the protruded portion of the nearest manifold pipe and the furthest manifold pipe is greater than that of the middle manifold pipe in a range between approximately 3% and approximately 5%. In this case, unevenness of distribution of the intake air between the cylinders is reduced equal to or less than 3%, which is an empirical allowable limit of the unevenness of distribution.

For example, the air intake device is employed to a gasoline engine having more than three cylinders arranged in line, such as an in-line four cylinder gasoline engine.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1A is a graph showing unevenness of distribution of intake air between cylinders of an internal combustion engine by an air intake device according to an embodiment of the present invention;

FIG. 1B is a schematic view of the air intake device, partly including a cross-section, according to the embodiment;

FIG. 2A is a graph showing suction pressure of cylinders of an internal combustion engine and unevenness of distribution of intake air between the cylinders by an air intake device having a structure of a prior art and which is measured this time; and

FIG. 2B is a schematic view of the air intake device of the prior art.

### DETAILED DESCRIPTION OF EXEMPLARY EMBODIMENT

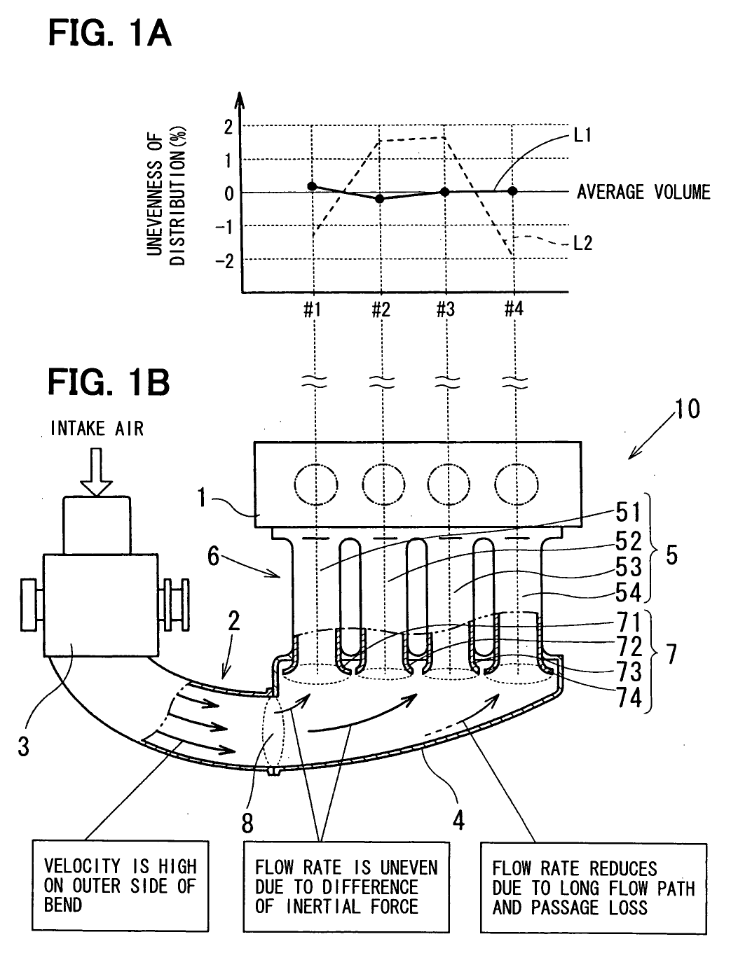

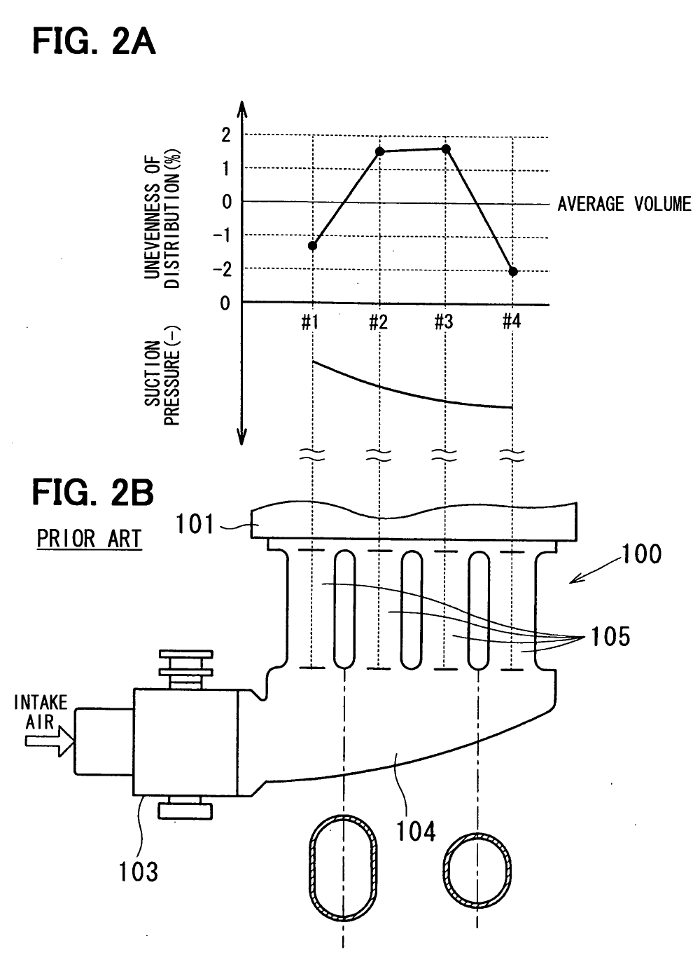

An embodiment of the present invention will be described with reference to FIGS. 1A and 1B. Referring to FIG. 1B, an air intake device 10 of the present embodiment is, for example, employed to an in-line multiple-cylinder engine as an internal combustion engine (hereinafter, simply referred to as the engine), such as in-line four cylinder gasoline engine. The air intake device 10 generally includes a surge tank 4 for alleviating variation in pressure of a flow of intake air, which is to be introduced in the engine, and an intake manifold 6 for distributing the intake air between cylinders of the engine. The surge tank 4 is connected to an air intake pipe 2 that is disposed downstream of a throttle body 3, which is provided for adjusting the flow rate of the intake air. The intake manifold 6 has plural manifold pipes 5 for separately conducting the intake air into the cylinders. The surge tank 4 is formed separately from the intake manifold 6, and is coupled to the intake manifold 6. Alternatively, the surge tank 4 can be integrally formed with the intake manifold 6.

The surge tank 4 is disposed upstream of the intake manifold 6 such that its longitudinal direction is substantially parallel to an alignment direction of the cylinders. The manifold pipes 5 are aligned in the longitudinal direction of the surge tank 4, that is, from an upstream position to a downstream position with respect to the flow of the intake air in the surge tank 4. Further, each of the manifold pipes 5 is perpendicular to the longitudinal direction of the surge tank 4. The manifold pipes 5 are disposed such that the intake air is introduced in the corresponding cylinders in a direction substantially perpendicular to a crank shaft, that is, the alignment direction of the cylinders.

Although not illustrated, an air cleaner is provided upstream of the throttle body 3. Thus, the intake air is introduced in the throttle valve 3 after being filtered by the air cleaner. The intake air, whose flow rate has been adjusted by the throttle valve 3, is introduced in the surge tank 4 through the air intake pipe 2. The surge tank 4 has a predetermined volume. The velocity of the intake air is reduced in the surge tank 4, and dynamic pressure of the intake air is converted into static pressure. After the variation in pressure of the intake air is alleviated, the intake air is distributed between the cylinders of the engine 1 through the manifold pipes 5.

The surge tank 4 is constructed of a generally tubular body (tank body) and defines a tank space (chamber) therein. The tubular body has a generally rectangular or round shape in a cross-section defined perpendicular to its longitudinal axis. The surge tank 4 is disposed such that its longitudinal direction is substantially parallel to the alignment direction of the cylinders. The surge tank 4 has an inlet port 8 at an end. The inlet port 8 is coupled to the air intake pipe 2. Thus, the air flows in the surge tank 4 from the inlet port 8, and flow toward the other end of the surge tank 4.

The manifold pipes 5 are aligned along an inner wall of the tubular body of the surge tank 4. To easily and evenly distribute the intake air between the manifold pipes 5 from the surge tank 4, an outer wall of the tubular body, which is opposite to the engine 1 with respect to the inner wall, is evenly curved outwardly, such as in a generally convex shape, so that a cross-sectional area of the surge tank 4 is gradually reduced in the longitudinal direction. Hereinafter, “inner side” and “inner portion” of the surge tank 4 means an engine side of the surge tank 4 and “outer side” and “outer portion” of the surge tank 4 means a further side of the surge tank 4 with respect to the engine 1. The outer wall of the surge tank 4 is further than the inner wall with respect to the engine 1.

Each of the manifold pipes 5 is a tubular member defining a passage therein for allowing the intake air to flow. The tubular member has a rectangular or round shape in a cross-section. The manifold pipes 5 are aligned in the longitudinal direction of the surge tank 4 and are separately coupled to the surge tank 4. Specifically, a first end portion of each manifold pipe 5 is coupled to the inner wall of the surge tank 4. Further, each manifold pipe 5 is substantially perpendicular to the longitudinal direction of the surge tank 4. A second end portion of each manifold pipe 5 is in communication with the corresponding cylinder in a direction perpendicular to the alignment direction of the cylinders. In the surge tank 4, the intake air is biased toward the inner side and is distributed between the cylinders through the manifold pipes 5.

In the present embodiment, the engine has four cylinders, for example. Thus, the intake manifold 6 has four manifold pipes 5. Here, the cylinders are referred to as first to fourth cylinders as a function of distance from the inlet port 8 of the surge tank 4. That is, the cylinder that is closest to the inlet port 8 is referred to as the first cylinder, and the cylinder that is furthest from the inlet port 8 is referred to as the fourth cylinder. The manifold pipe 5 that is in communication with the first cylinder is referred to as a first manifold pipe 51. The manifold pipe 5 that is in communication with the fourth cylinder is referred to as a fourth manifold pipe 54. The manifold pipes 5 that are between the first and fourth manifold pipes 51, 54 are referred to as second and third manifold pipes 52, 53. In other words, the intake manifold 6 has the first to fourth manifold pipes 51, 52, 53, 54 with respect to the flow of the intake air in the surge tank 4. The first manifold pipe 51 can be also referred to as a nearest manifold pipe, and the fourth manifold pipe 54 can be also referred to as a furthest manifold pipe. Also, the second and third manifold pipes 52, 53 can be referred to as middle manifold pipes.

The first end portions of the manifold pipes 5 are protruded inside of the surge tank 4 and provide protruded portions 7. Each of the protruded portions 7 has a funnel shape in which an opening, such as an inside diameter, increases toward its distal end in the form of quadrant. Specifically, the first to fourth manifold pipes 51, 52, 53, 54 provide first to fourth protruded portions 71, 72, 73, 74 at the first end portions, respectively.

The funnel shape is known as a shape for increasing efficiency of a fluid flow. When the intake air is introduced in each manifold pipe 5 through the opening of the funnel-shaped protruded portion 71, 72, 73, 74, the intake air passes through the first end portion while filling the opening of the first end portion entirely along its inner surface without causing contraction. Thus, the efficiency of flow rate increases. In the case where the protruded portion 7 has the funnel shape, air intake efficiency greatly improves, as compared with a case where the protruded portion 7 does not have the funnel shape.

In the air intake device 10, in a case where the surge tank 4 has the sufficient volume and the variation in pressure is sufficiently alleviated in the surge tank 4, a large volume of intake air is evenly distributed between the cylinders through the funnel-shaped protruded portions 7. However, in a case where the volume of the surge tank 4 is limited and the variation in pressure of intake air is not sufficiently alleviated, dynamic pressure remains. In this case, the dynamic pressure affects as inertial force of the flow, resulting in uneven distribution of the intake air between the cylinders as a conventional example.

Hereinafter, an operation of the air intake device 10 and influence of the inertial force due to the dynamic pressure will be described.

As shown in FIG. 1B, the flow rate of the intake air is adjusted by the throttle body 3 after the intake air is filtered through the air cleaner. Then, the intake air is introduced in the surge tank 4 through the air intake pipe 2 having a bend. When the intake air passes through the air intake pipe 2, velocity distribution in which velocity of the intake air is higher at an outer side of the bend than an inner side of the bend is generated due to the bend. The more the curvature of the bend increases, the more the velocity distribution is large. Thus, the intake air is introduced in the surge tank 4 while having unevenness in the flow rate.

When being introduced in the surge tank 4, the velocity of the intake air is decelerated because of a volume of the surge tank 4. Because the dynamic pressure due to the velocity is converted into static pressure, the variation in pressure is alleviated. However, in the case where the surge tank 4 has a predetermined limited volume, the velocity of the intake air is not immediately decelerated. Further, momentum of the flow rate or the velocity exerts as the inertial force and causes uneven distribution of the flow rate in the surge tank 4. That is, the flow rate of the intake air is higher on the outer side than the inner side, in the surge tank 4.

Further, the cross-sectional area of the surge tank 4 gradually reduces from its upstream position toward its downstream position, with respect to the longitudinal direction of the surge tank 4. Therefore, on the outer side of the surge tank 4, since the volume reduces in the flow direction and the flow path increases, the passage loss increases and thus the flow rate of the intake air reduces. In FIG. 1B, the flow direction and the flow rate or the velocity of the intake air are shown by solid arrows. As shown by the arrows in FIG. 1B, the intake air flows through the surge tank 4 in the generally longitudinal direction in a condition that the variation in pressure is still not sufficiently alleviated, and thus a biased flow pattern, that is, uneven flow pattern of the intake air in which the flow rate is small at the upstream position and the downstream position and is large at a midstream position between the upstream position and the downstream position is generated.

In such a case, if the protruded portions 7 of the manifold pipes 5 have the same opening area, the intake air is unevenly distributed between the cylinders. Therefore, in the present embodiment, the pattern of the flow rate of the intake air in the surge tank 4 is measured (simulated) previously in accordance with the shape and the volume of the surge tank 4, and the opening areas of the ends of the protruded portions 7 are varied such that the intake air is substantially evenly distributed between the cylinders while absorbing the unevenness of the flow rate.

In the above discussion, it is described that the velocity distribution of the intake air being introduced in the surge tank 4 causes the biased flow pattern having the flow rate distribution by being affected by the inertial force of the flow in the surge tank 4. However, since the velocity and the flow rate are considered as equivalent, the flow rate distribution can be regarded as the velocity distribution, and the flow rate pattern can be regarded as the velocity pattern. The flow rate pattern can be simulated based on either the velocity or the flow rate, which is easy to measure or simulate.

In the conventional example, the unevenness of distribution of the intake air between the cylinders is measured as shown by a dotted line L2 in FIG. 1A. Therefore, in the present embodiment, the opening areas of the protruded portions 7 are varied in accordance with the range of the unevenness of the distribution of the conventional example.

For example, the opening area of the end of the first and fourth protruded portions 71, 74 is approximately 3% larger than that of the end of the second and third protruded portions 72, 73. In this case, the unevenness of distribution of the intake air between the cylinders can be reduced within approximately 1%, as shown by a solid line L1 in FIG. 1A. Accordingly, substantially even distribution of the intake air between the cylinders is achieved.

In a case where the opening area of the end of the first and fourth protruded portions 71, 74 is approximately 5% larger than that of the end of the second and third protruded portions 72, 73, the unevenness of the distribution of the intake air between the cylinders is reduced within approximately 3%. That is, to reduce the unevenness of distribution of the intake air between the cylinders equal to or less than approximately 3%, it is preferable to vary the opening areas of the ends of the protruded portions 7 in a range between approximately 3% and approximately 5%, in the air intake device 10 for the engine 1.

(Operation)

Next, an operation of the air intake device 10 with the above structure will be described. When the engine 1 is in operation, the intake air is introduced in the air intake pipe 2 after the flow rate of the intake air is adjusted by the throttle body 3. The intake air flows in the surge tank 4 from the air intake pipe 2 while having the specific velocity distribution.

The velocity of the intake air is reduced once in the surge tank 4, which has a predetermined volume. At this time, although the velocity distribution of the intake air is alleviated, the intake air is introduced toward the downstream position and the inner side along the outer wall of the surge tank 4. Therefore, the flow rate distribution of the intake air, which is specific for the surge tank 4, is generated. Namely, while the intake air is being introduced from the upstream position toward the downstream position in the longitudinal direction of the surge tank 4 to be distributed between the manifold pipes 5 that are aligned in the longitudinal direction of the surge tank 4, the flow rate distribution of the intake air in which the flow rate of the upstream and downstream positions is smaller than that of the midstream position between the upstream and downstream positions is generated.

The intake air is introduced into the first to fourth manifold pipes 51, 52, 53, 54 while maintaining the flow rate distribution. In the present embodiment, since the opening areas of the ends of the protruded portions 71, 72, 73, 74 are varied in accordance with the flow rate distribution or the velocity distribution, the intake air is substantially evenly distributed between the cylinders.

(Advantageous Effect)

In the present embodiment, the opening area of the end of the protruded portion 7 is varied between the manifold pipes 5 to cope with the velocity distribution. Therefore, even when the variation in pressure of the intake air in the surge tank is not sufficiently alleviated and the velocity distribution of the intake air remains, the intake air is substantially evenly distributed between the cylinders. The opening areas of the protruded portions 7 of the manifold pipes 5 can be determined by simulating the flow rate distribution. As such, the influence of the specific flow rate distribution is easily reduced, without requiring an increase in the volume of the surge tank 4 and a distribution plate.

Since the opening areas of the ends of the protruded portions 7 of the manifold pipes 5 are varied in the above manner, the air intake efficiency improves and the intake air is substantially evenly distributed between the cylinders. Accordingly, the operation of the engine 1 is stabilized. Further, the noise during idling is reduced and the increase in the rotational speed of the engine 1 is improved.

Further, in the case where the opening area of the end of the first and fourth protruded portions 71, 74 is larger than that of the end of the second and third protruded portions 72, 73 in the range between approximately 3% and approximately 5%, the unevenness of distribution of the intake air between the cylinders is reduced equal to or less than approximately 3%.

(Modifications)

In the above embodiment, the air intake device 10 is exemplarily employed to the in-line four-cylinder engine. However, the air intake device 10 can be employed to an in-line multiple-cylinder engine having more than three cylinders. That is, the air intake device 10 can be employed to an in-line three-cylinder engine, an in-line six-cylinder engine, and the like.

In the case where the air intake device 10 is employed to such an in-line multiple cylinder engine, if the variation in pressure of the intake air is not sufficiently alleviated, the intake air is distributed between the manifold pipes while maintaining the velocity distribution. The velocity distribution has the velocity pattern in which the velocity is reduced at the upstream and downstream positions and is increased at the midstream position. Therefore, the opening area of the end of the protruded portions that are nearest to the inlet port 8 and furthest from the inlet port 8 is set larger than the opening area of the end of the remaining protruded portions so that the intake air is substantially evenly distributed between the cylinders.

In the above embodiment, the surge tank 4 has the second wall that is curved outwardly. However, the shape of the surge tank 4 is not limited to the above discussed and illustrated shape. For example, depending on an installation condition of a surge tank in a vehicle, the second wall may have a flat shape or include a bend. Even in such a surge tank, in a case where the intake air has the velocity distribution in the surge tank, the opening area of the end of the protruded portion can be varied in accordance with velocity of the intake air flowing toward the end of each protruded portion.

Additional advantages and modifications will readily occur to those skilled in the art. The invention in its broader term is therefore not limited to the specific details, representative apparatus, and illustrative examples shown and described.

What is claimed is:

1. An air intake device for an in-line multiple cylinder engine, comprising:
a surge tank having a substantially tubular body and an inlet port at an end of the tubular body for allowing intake air to flow in the tubular body, the tubular body having a first wall and a second wall, the second wall being curved such that a cross-sectional area of the tubular body gradually reduces as a function of distance from the inlet port in a longitudinal direction of the tubular body; and
an intake manifold for distributing the intake air from the surge tank between cylinders of the engine, the intake manifold having a plurality of manifold pipes aligned in the longitudinal direction of the surge tank and disposed substantially perpendicular to the first wall of the surge tank, each of the manifold pipes having a first end portion connected to the first wall of the surge tank and a second end portion to be connected to the corresponding cylinder, wherein
the first end portion of each manifold pipe has a protruded portion protruded in the surge tank, the protruded portion has a funnel shape in which an opening increases toward its end, and
an opening area of the end of the protruded portion is varied between the plurality of manifold pipes in accordance with velocity of the intake air flowing toward the end of each protruded portion in the surge tank.

2. The air intake device according to claim 1, wherein
the plurality of manifold pipes includes a nearest manifold pipe that is nearest to the inlet port, a furthest manifold pipe that is furthest from the inlet port and at least one middle manifold pipe that is located between the nearest manifold pipe and the furthest manifold pipe, and
the opening area of the end of the protruded portion of the nearest manifold pipe and the furthest manifold pipe is greater than that of the middle manifold pipe.

3. The air intake device according to claim 2, wherein
the opening area of the end of the protruded portion of the nearest and furthest manifold pipes is greater than that of the middle manifold pipe in a range between approximately 3% and approximately 5%.

4. The air intake device according to claim 1, wherein
the plurality of manifold pipes includes a first manifold pipe, a second manifold pipe, a third manifold pipe and a fourth manifold pipe, the first manifold pipe being nearest to the inlet port, the fourth manifold pipe being furthest from the inlet port, the second and third manifold pipes being located between the first manifold pipe and the fourth manifold pipe, and
the opening area of the end of the protruded portion of the first and fourth manifold pipes is greater than that of the second and third manifold pipes in a range between approximately 3% and approximately 5%.

5. An air intake device for an in-line multiple cylinder engine, comprising:
a surge tank having a tank body and an inlet port at an end of the tank body for introducing intake into the tank body; and
an intake manifold for distributing the intake air from the surge tank between cylinders of the engine, the intake manifold having a plurality of manifold pipes aligned in a longitudinal direction of the tank body and disposed substantially perpendicular to the longitudinal direction of the tank body, each of the manifold pipes having a first end portion connected to the tank body and a second end portion to be connected to the corresponding cylinder, wherein
the first end portion of each manifold pipe has a protruded portion protruded in the tank body, the protruded portion has a funnel shape in which an opening increases toward its end, and
an opening area of the end of the protruded portion is varied between the plurality of manifold pipes in accordance with velocity of the intake air flowing toward the end of each protruded portion in the tank body.
